(19) United States
(12) Patent Application Publication
(10) Pub. No.: US 2003/0154372 A1
(43) Pub. Date: Aug. 14, 2003

(54) Secure remote data acquisition method and system

(76) Inventor: Chester J. Barszcz, Las Vegas, NV (US)

Correspondence Address: Erik R. Nordstrom, Fulbright & Jaworski L.L.P., Suite 2400, 600 Congress Avenue, Austin, TX, 78701, US

(21) Appl. No.: 10/074,090

(22) Filed: Feb. 12, 2002

(51) Int. Cl. H04L 9/00

(52) U.S. Cl. 713/161

(57) ABSTRACT

The present invention provides a computer implemented method for acquiring secure test result data. In one embodiment, the method comprises presenting a test to a test subject through a computer device. Raw test response data based on the subject's response to the presented test is received from the test subject. The raw data is processed to generate test result data. The test result data is encrypted to generate encrypted test result data. The encrypted test result data is made available to a user, but unencrypted raw test response and result data is not accessible. In this way, only users with access to the decryption method for decrypting the encrypted result data have practical access to test result and raw data received from the test subject.

### BACKGROUND OF THE INVENTION

1. Field of the Invention

The invention relates generally to the field of computerized testing. More particularly, the invention relates to neuro-psychological computer-assisted testing. Specifically, a preferred implementation of the invention relates to neuro-psychological computer-based testing administration via a portable computing platform.

2. Discussion of the Related Art

The use of computerized neuro-psychological tests has been increasing in the past several years. Such tests have proved to be very useful in measuring cognitive ability, and have demonstrated to work very well in determining the effectiveness of certain drugs. One of the advantages of computer-assisted tests is that they allow a certain amount of quality control, that is, tests can be executed in the same way under different conditions (different times, locations, administrators, raters, etc.).

In several clinical drug trials, such as an Alzheimer's trial or a schizophrenia trial, it may be necessary to measure a patient's brain function. In many cases, one needs to know the effects of clinical drugs on the patient's ability to think and remember by means of tests. These tests are usually presented in the form of a battery of modules, wherein each module can contain an independent test.

Food and Drug Administration (FDA) regulations do not allow the storage of patient test data on a remote computer system in a form which could be intentionally or unintentionally altered. Specifically, an FDA regulation relating to security requirements can presently be found in 21 C.F.R. Part 11. It effectively prevents the use of laptop computers and other sorts of portable computing platforms in conjunction with contemporary database management software to collect data from clinical trials at remote sites.

Heretofore, the requirements of organizing test data into a format that meets FDA security requirements and allows the use of laptop computers and other forms of portable computing equipment to perform neuro-psychological tests, referred to above has not been fully met. What is needed is a solution that addresses tests to be remotely implemented through a computing device.

### SUMMARY OF THE INVENTION

The present invention provides a computer implemented method and system for acquiring secure test result data. In one embodiment, the method comprises presenting a test to a test subject through a computer device. Raw test response data based on the subject's response to a presented test is received from the test subject. The raw data is processed to generate test result data. The test result data is encrypted to generate encrypted test result data. The encrypted test result data is made available to a user, but unencrypted raw test response and result data is not accessible. In this way, only users with access to the decryption method for decrypting the encrypted result data have practical access to test result and raw data received from the test subject.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numerals (if they occur in more than one view) designate the same elements. The invention may be better understood by reference to one or more of these drawings in combination with the description presented herein. It should be noted that the features illustrated in the drawings are not necessarily drawn to scale.

FIG. 1 illustrates a diagram of a computerized, remote test administration site, representing an embodiment of the invention.

FIG. 2 illustrates a combination data flow/block diagram showing one embodiment of an overall test system of the present invention.

FIG. 3 illustrates a block diagram of a computer device, representing an embodiment of the invention.

FIG. 4 illustrates a routine for implementing one embodiment of a test program.

### DESCRIPTION OF PREFERRED EMBODIMENTS

The invention and the various features and advantageous details thereof are explained more fully with reference to the embodiments that are illustrated in the accompanying drawings and detailed in the following description. Descriptions of well known components and processing techniques are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this detailed description

Remote Test Site

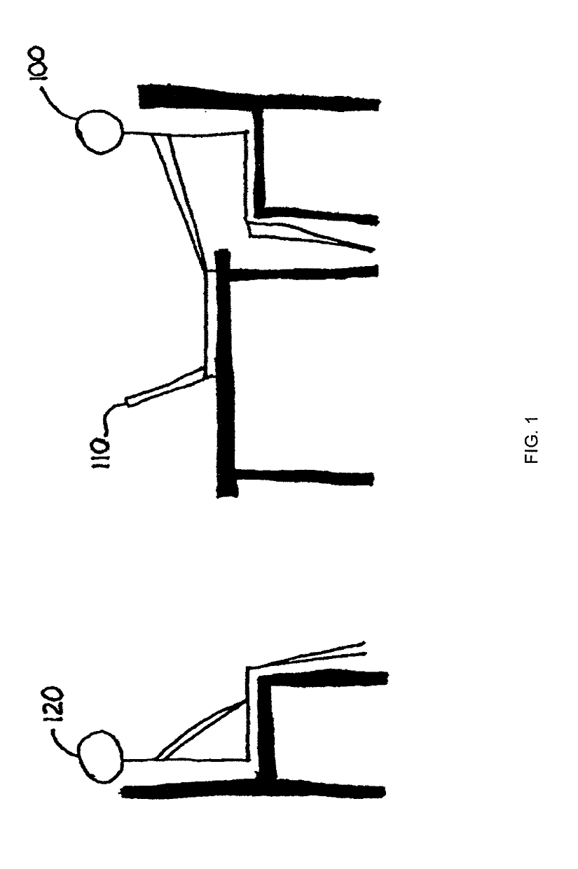

Referring to FIG. 1, a simplified diagram of an exemplary remote test administration site is depicted. The remote test site generally includes a test administrator 100, a computing device 110 (executing a test program not shown), and a test subject 120. The computing device 110 is used by the test administrator 100 to provide the test subject 120 with a series of one or more tests. The series of tests may include neurological and psychological exams and are typically used to measure the effects and/or efficacy of a selected drug of interest. The executing test program may comprise a computerized neuro-psychological test battery (“CNTB”).

A CNTB is a series of one or more computer-implemented, neurological tests. In one embodiment, the CNTB test program is a psychometric-validated, testing program for implementing the one or more tests. Psychometric validated tests are typically documented according to FDA compliance requirements. Psychometric validated test software can comprise one or more modules for presenting the test subject 120 with a battery of tests selected by an experienced expert (e.g., neuro-psychologist), and may measure a wide variety of cognitive functions including verbal memory, spatial memory, naming, and speed of information processing.

For example, in one CNTB test, a screen displayed word list is read by the administrator with the patient not viewing the screen. The administrator may see, for example, 15 words appearing in a certain sequence on the screen. The administrator says the words in the displayed order and asks the subject to repeat them back. The responses are entered into the computing device and evaluated by the executing test program. On a second pass, it may then display only the words not correctly repeated, and the administrator again enters the responses into the computer device. This cycle may repeat until the test subject has successfully verbalized each of the original 15 words, or it may continue for a predefined number of cycles.

In another test example, simple reaction time is measured. The computer device screen is turned toward the subject. The subject may then be prompted to press the space bar when a certain character or graphic appears on the screen. The computer device then measures the subject's reaction time and accuracy based on its responses.

Thus, it can be seen that computer devices are highly effective for consistently and efficiently presenting the test(s) to a test subject. Not only is the computer useful for presenting, receiving and organizing the test stimuli and response data, but also, it is well suited to control and measure relevant timing parameters.

Clinical Study Data Gathering Scheme

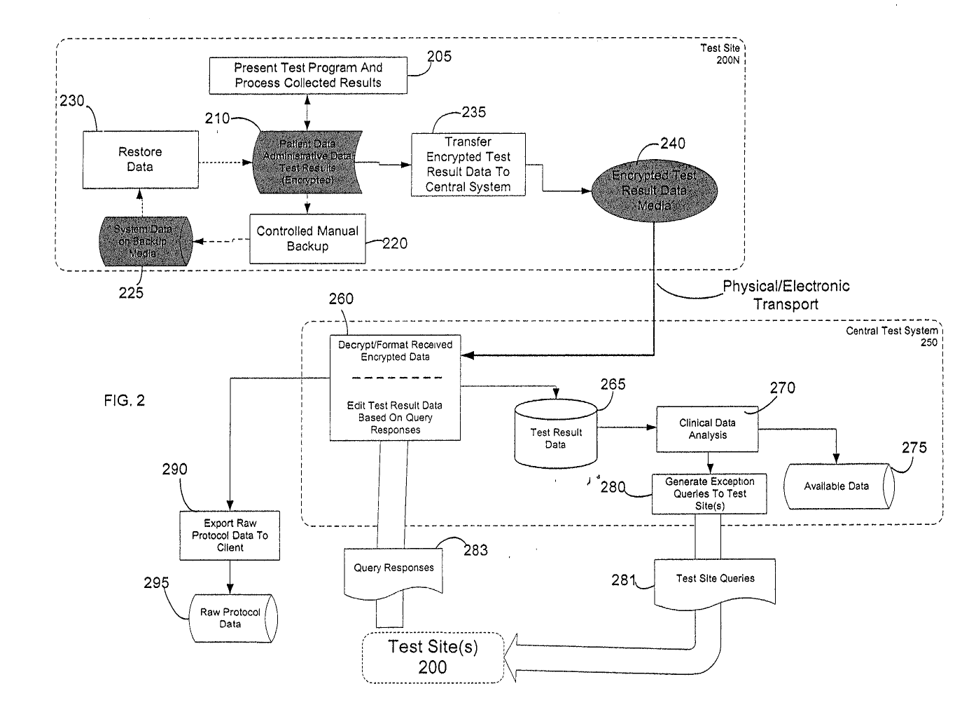

Referring to FIG. 2, a combination data flow/block diagram showing one embodiment of an overall test system of the present invention is depicted. At 205, a CNTB test program at a test site 200N is executed in order to administer the test to a test subject. The test program (through a computer device) receives test subject, administrator, and raw test response data. It processes the raw test response data and generates a test results data file. This can involve, for example, calculating a response time to a stimulus and organizing response data into a pre-specified format. The data, including the subject, administrator, and processed response data, is encrypted into encrypted results data, which is represented at 210 (the shaded blocks identify encrypted data).

A back-up system is represented at 220, 225, and 230. Either manually, periodically, or in response to some other indicator, a controlled back-up file(s) 225 of the encrypted results data is generated at step 220. If needed (e.g., if the memory storage media incurs damage), the backed up data at 225 can be used to restore the data back to its undamaged state at step 230.

At step 235, the encrypted test result data is transferred to a central test system 250. In the depicted embodiment, the encrypted data is physically transferred to the central system with a portable memory storage media 240 such as a CD ROM. However, it could be transmitted via any suitable alternative such as over a public network, a virtual private network or a wireless transmission.

The encrypted test result data is received and decrypted within the central processing system at 260, which may correspond to a user operating a computer work station or an automatic processing system, for example. Here, the decrypted data is formatted and stored on a test result database server at 265. At 270, the data is analyzed by a clinical data analysis program such as an executing Oracle Clinical™ application, which is available from Oracle Corporation of Redwood City, Calif. At 260, the data is stored in data server 265 and is suitably formatted for the particular data analysis program being utilized. For example, in the depicted embodiment, an Oracle Clinical™ format is used in conjunction with the implemented Oracle Clinical™ data analysis program.

In one embodiment, the clinical data analysis program checks the formatted test result data to identify datum outlyers that fall outside of predefined, expected test result ranges. When “outlying” data is identified, a query 281 is submitted to the corresponding test site 200 where the data was collected. In this context, a query is any suitable communication (e.g., voice message, e-mail, computer command string, delivered requisition) that causes the test site to investigate the particular data anomaly. Once the test site determines the cause of the outlying data, it sends back to the central test system 250 a query response 283 that explains the cause of the outlying data. The response could consist of a variety of explanations such as (1) the datum was validly collected indicating that the expected data range was not accurately defined, (2) the datum is not valid due to some identified reason, e.g., the computer device keyboard had a faulty key, or (3) some other acceptable explanation.

From here, the test result data 265 is appropriately edited based on the received query response. For example, if the query response contains corrected data, the corresponding originally received data is updated with the correct data. On the other hand, if it was determined that the outlying datum was validly collected, then it is tagged as such so that the clinical data analyzer at 270 will not again identify it as an outlyer. Once the clinical analysis program has processed all pertinent data for a defined data set in the test result database 260 and determines that there are no unresolved outlying datums, it makes the data available at 275 for use in a study. In addition, a copy of the raw protocol data 295 is exported to the client sponsoring or associated with the study. This may be done simply for archival purposes and is represented at 290.

Computing Device

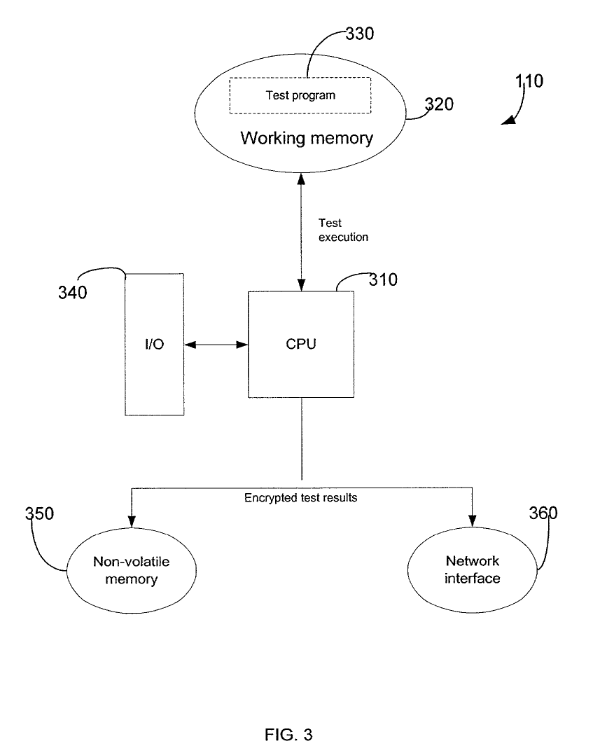

Referring to FIG. 3, a block diagram of one embodiment of a computer device 110 is shown. The depicted device generally includes a central processing unit (“CPU”) 310, working memory 320, input/output (“I/O”) devices 340, non-volatile memory 350, and a network interface 360. The CPU 310 is operably coupled to the I/O devices 340, the nonvolatile memory 350, the network interface 360, and the working memory 320, which, in turn, contains an executable test program 330.

The CPU 310 controls the overall operation of computer device 110 and executes program instructions from test program 330. It may be implemented with any suitable device (or combination of devices) for performing these functions. Such devices could include but are not limited to micro-controllers, micro-processors, multi-processor modules and separate computers.

Similarly, the I/O devices 340, volatile memory 350, network interface 360, and working memory 320 may be implemented with conventional devices for performing their indicated functions.

The I/O devices, among other things, provide users (e.g., test administrators, test subjects) with access to the computer device 110 and in turn to an executing test program 330. They allow test program information (cues, instructions, prompts, etc) to be displayed to users, and they receive from users raw test data entered into the computer device 110. They may also incorporate parts of the non-volatile memory 350 and network interface 360. The I/O devices 340 could include but are not limited to monitors (e.g., touch-screen, flat panel, conventional CRT), pointing devices, mice, keyboards, drawing pads, cameras, and microphones.

The non-volatile memory 250 stores files including encrypted test data files—even when the computer device 110 is powered down. Notwithstanding security measures used by the given computer device 110, any person could potentially have access to the non-volatile memory 350, and thereby, to the files stored within it. Accordingly, test data files are encrypted prior to being stored in non-volatile memory 350. Memory 350 may include any suitable non-volatile memory including but not limited to compact discs, digital versatile discs, diskettes, zip disks, multimedia cards, secure digital cards, extension cards, additional magnetic storage media such as hard-drives, flash memory, or even separate computers and file-servers.

The network interface 360 communicatively links the computer device 110 to a network (not shown) so that encrypted test data files can be transmitted to or retrieved from a remotely located computer (e.g., a central database server). Accordingly, the network interface comprises appropriate hardware/software such as a modem or a network card for linking the CPU 310 to a particular network. The network could be any network such as a local area network, a virtual private network, a wireless network, and the internet. It could also include a dial-up direct connection to a receiving computer at, e.g., a central database site. A wide variety of networks and network protocols are available, all of which need not be detailed here.

Finally, the working memory 320 contains the test program 330, when it is being executed by CPU 310 for presenting a test to a user. The working memory 320 may include cache memory, random access memory (“RAM”), magnetic storage memory and/or any combination of read/write memory components such as with a virtual memory system. It may also incorporate part of the non-volatile memory 350—as is typically the case when a virtual memory is used. It could also at least partially exist in the CPU 310, as is the case, for example, with internal (Level 1) cache memory in a micro-processor.

An encryption routine for encrypting test response data may be implemented with any suitable scheme by computer device 110. For example, it could be performed by a separate dedicated circuit, program or controller within the computer device 110, or alternatively, it could be implemented as an integral part of the test program 330. Any conventional or custom-created encryption algorithm could be used to encrypt the test response data. For example, encryption methods can include private key algorithms such as: DES, Blowfish, IDEA, LOKI, RC4; public key algorithms such as Diffie-Hellman, ElGamal, and RSA; signature algorithms such as DSA; and hash algorithms such as: MD5, Haval, and SHA. A preferred embodiment of the invention involves a combination of algorithms. A wide variety of encryption and decryption methods are known to one skilled in the art, all of which need not be detailed here.

Test Program

During test administration and execution, the central processing unit 310 interacts with the I/O devices 340 and with the working memory 320 to run the test program 330 and obtain raw test response and reference (e.g., administrative, test subject, test site) data.

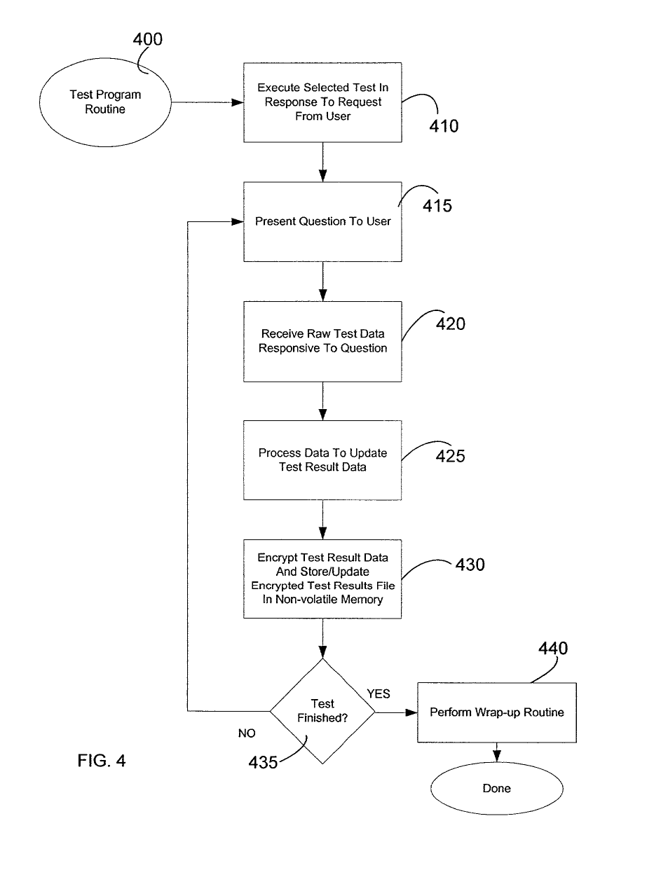

With reference to FIG. 4, one embodiment of a test program routine is presented. Initially, at step 410, a selected test program module is executed in response to a request from a user (e.g., a test administrator). At step 415, test questions are presented to a user (either through the test administrator or directly to the test subject), and raw response data is received at step 420. At step 425, the routine processes the received response data and updates a test results file based on the received response data. As addressed previously, depending upon the particular type of test (or test module) being presented, processing can involve various forms of data manipulation including but not limited to averaging, formatting, accumulating, sorting, measuring, monitoring, scoring, and organizing. In addition, processing can occur within CPU 310, working memory 320 and possibly even non-volatile memory 350 (e.g., when a hard-drive memory is used in an active virtual memory system).

Next, at 430, the processed result data is encrypted into an encrypted result file. The encrypted result file is stored (or updated) in non-volatile memory 350. After this encryption step, the contents of the working memory 220 (including processed result data and raw data no longer needed for generating a processed result data file) may be deleted or organized into an inaccessible format. In a preferred embodiment of the invention, all raw and processed data is encrypted prior to being written into non-volatile memory 350 or transmitted through network interface 360 thereby making it accessible only by the test group that administers the clinical trial. In addition, after it is no longer needed, unencrypted raw and processed data is deleted in working memory 320, thereby complying with current FDA regulations.

Steps 415 and 430 repeat and continue until at determination step 435, it is determined that the test has completed. If so, then the routine proceeds to step 440 and performs a wrapup routine. The wrap-up routine may comprise various tasks such as cataloging encrypted result data file(s), checking for any unencrypted data and obscuring (e.g., eliminating) such data if detected.

Remarks

The invention relates generally to the field of computerized testing. More particularly, the invention relates to neuro-psychological computer-assisted testing. Specifically, a preferred implementation of the invention relates to neuro-psychological computer-based testing administration via portable computing platforms.

The context of the invention can include computerized testing. The context of the invention can also include neuro-psychological computer-assisted testing and neuro-psychological computer-based testing administration via a portable computing platform.

The invention can include methods and systems for administering neuro-psychological computer-based testing administration via a portable computing platform, while complying with Food and Drug Administration regulations.

The invention can also be included in a kit. The kit can include some, or all, of the components that compose the invention. The kit can be an in-the-field retrofit kit to improve existing systems and conventional CNTB test programs that are capable of incorporating the invention. The kit can include software, firmware and/or hardware for carrying out the invention. The kit can also contain instructions for practicing the invention. Unless otherwise specified, the components, software, firmware, hardware and/or instructions of the kit can be the same as those used in the invention.

The term approximately, as used herein, is defined as at least close to a given value (e.g., preferably within 10% of, more preferably within 1% of, and most preferably within 0.1% of). The term substantially, as used herein, is defined as at least approaching a given state (e.g., preferably within 10% of, more preferably within 1% of, and most preferably within 0.1% of). The term coupled, as used herein, is defined as connected, although not necessarily directly, and not necessarily mechanically. The term deploying, as used herein, is defined as designing, building, shipping, installing and/or operating. The term means, as used herein, is defined as hardware, firmware and/or software for achieving a result. The term program or phrase computer program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system. The phrase any integer derivable therein, as used herein, is defined as an integer between the corresponding numbers recited in the specification, and the phrase any range derivable therein is defined as any range within such corresponding numbers. The terms including and/or having, as used herein, are defined as comprising (i.e., open language). The terms a or an, as used herein, are defined as one or more than one. The term another, as used herein, is defined as at least a second or more.

A practical application of the invention that has value within the technological arts is a Food and Drug Administration compliant remote data acquisition method and system. The invention is useful in conjunction with neuro-psychological test software. Further, the invention is useful in conjunction with desktop computing platforms, portable computing platforms, or the like. There are virtually innumerable uses for the invention, all of which need not be detailed here.

It will be appreciated by those skilled in the art that the invention may be practiced otherwise than as specifically described herein.

Further, the individual components need not be formed in the disclosed shapes, or combined in the disclosed configurations, but could be provided in virtually any shapes, and/or combined in virtually any configuration. Further, the individual components need not be fabricated from the disclosed materials, but could be fabricated from virtually any suitable materials.

Further, although the secure remote data acquisition method and system described herein can be a separate module, it will be manifest that the secure remote data acquisition method and system may be integrated into the system with which it is associated. Furthermore, all the disclosed elements and features of each disclosed embodiment can be combined with, or substituted for, the disclosed elements and features of every other disclosed embodiment except where such elements or features are mutually exclusive.

It will be manifest that various substitutions, modifications, additions and/or rearrangements of the features of the invention may be made without deviating from the spirit and/or scope of the underlying inventive concept. It is deemed that the spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

### REFERENCES

Advanced Encryption Standard Call, NIST, 1997

Applied Cryptography—Protocols, Algorithms and Source Code in C, 2^{nd} ed., Bruce Schneier eds., John Wiley & Sons, 1996.

Differential Cryptanalysis of the Data Encryption Standard, Eli Biham et al. eds., Pringer-Verlag, 1993.

Network and Internetwork Security—Principles and Practice, W. Stallings eds., Prentice-Hall, 1995.

New Types of Cryptanalytic Attacks Using Related Keys, Eli Biham et al. eds., Journal of Cryptology, Vol. 7, No. 4, pp. 229-246, 1994.

What is claimed is:

1. A computer-implemented method for acquiring secure test result data, comprising:
(a) presenting a test to a test subject through a computer device;
(b) receiving from the test subject raw test response data based on the subject's response to the presented test;
(c) processing the raw data to generate test result data;
(d) encrypting the test result data to generate encrypted test result data; and
(e) making the encrypted test result data available to a user, wherein unencrypted raw test response and unencrypted test result data within the computer device is not accessible.

2. The method of claim 1, wherein presenting a test subject with a test through a computer device includes utilizing a laptop computer.

3. The method of claim 1, wherein processing the test response data to generate the test result data includes scoring the test subject's responses to cognitive function questions.

4. The method of claim 1, further comprising organizing unencrypted raw response and result data into an inaccessible format.

5. The method of claim 4, wherein organizing the unencrypted raw response data and test result data into an inaccessible format includes deleting it from a working memory if it is no longer required for generating the encrypted test result data.

6. The method of claim 1, wherein making the encrypted test result data available to a user includes writing the encrypted result data to a non-volatile memory media.

7. The method of claim 1, wherein making the encrypted test result data available to a user includes transmitting the encrypted result data out of the computer device over a network to a receiving computer device.

8. The method of claim 1, wherein receiving from the test subject raw test response data includes receiving the raw test response data through a test administrator.

9. A memory storage device comprising computer readable program elements for implementing the method of claim 1.

10. A computer device comprising a test program for performing the method of claim 1.

11. A memory storage media with a computerized neuro-psychological test battery program having instructions that when executed by a computer device cause it to perform a method comprising:
(a) presenting a test subject with a neuro-psychological test;
(b) receiving from the test subject raw data responsive to the presented test;
(c) generating a test result file based on the raw data;
(d) encrypting the test result file into an encrypted test result file;
(e) allowing the encrypted test result file to be accessed by a user; and
(f) preventing the unencrypted raw data and test result file from being accessed.

12. The memory storage media of claim 11, wherein allowing the encrypted test result file to be accessed by a user includes allowing it to be stored on a non volatile memory device.

13. The memory storage media of claim 11, wherein allowing the encrypted test result file to be accessed by a user includes allowing the encrypted file to be transmitted over a network to another computer device.

14. The memory storage media of claim 11, wherein presenting a test subject with a neuro-psychological test includes presenting a plurality of test modules to the test subject though a test administrator.

15. The memory storage media of claim 11, wherein generating a test result file based on the raw data includes processing the raw data into a predefined test result format.

16. The memory storage media of claim 11, wherein preventing the unencrypted raw data and test result file from being accessed includes organizing unencrypted raw response and result data into an inaccessible format.

17. The method of claim 16, wherein organizing the unencrypted raw data and test result data into an inaccessible format includes deleting it from a working memory if it is no longer required for generating the encrypted test result file.

18. A method for securely acquiring clinical test data with a computer device in one or more remote locations, comprising:
(a) at the one or more remote locations, presenting a test to at least one test subject through a computer device;
(b) receiving from the at least one test subject data in response to the presented test and inputting said data into the computer device;
(c) generating an encrypted test result file for the at least one test subject based on its inputted data, wherein received data that is not encrypted is not available outside of the computer device; and
(d) transferring the encrypted test result files for the at least one test subject from the one or more remote sites to a common database.

19. The method of claim 18, wherein inputting said data into the computer device includes inputting at least part of the data through a test administrator.

20. The method of claim 18, further comprising decrypting the encrypted test result files from the common database at a secure location in order to analyze the result files.
